(19) United States
(12) Patent Application Publication
(10) Pub. No.: US 2005/0189479 A1
(43) Pub. Date: Sep. 1, 2005

(54) Detecting device for detecting the rotation of a motor rotor

(76) Inventor: Wen-Wei Su, Xin-Feng Village (TW)

Correspondence Address: TROXELL LAW OFFICE PLLC, SUITE 1404, 5205 LEESBURG PIKE, FALLS CHURCH, VA, 22041, US

(21) Appl. No.: 10/786,028

(22) Filed: Feb. 26, 2004

(51) Int. Cl. G01D 5/34

(52) U.S. Cl. 250/231.13

(57) ABSTRACT

A detecting device for detecting the rotation of a motor rotor includes a light source, an identification mark means positioned around the motor rotor, and a sensor for detecting the light beams emitted by the light source and coming from the identification mark means. The identification mark means can be positioned on a cylindrical shoulder formed around the rotor thereby rotating with the motor rotor synchronously. The light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

### TECHNICAL FIELD

The present invention relates to a detecting device for detecting the rotation of a motor rotor, especially a detecting device which can achieve precise detection of the rotation of the motor rotor.

### DESCRIPTION OF RELATED ARTS

Various methods and devices have been employed to detect the rotation of a rotor of a motor. In fact, the methods and/or devices which are used for measuring or detecting a rotating shaft can also be adopted for detecting the rotor of a motor.

Traditionally, rotation sensors are adopted for detecting the rotation of a rotating shaft as above-mentioned. U.S. Pat. No. 4,030,066 gives a gyro which can be installed concentrically around the shaft connected with the steering wheel so that the turning angle of the wheel can be judged by detecting the turning angle of the shaft. There are also various devices except the gyro mechanism to detect the turning angle of a rotating shaft, such as a resonant rotation rate sensor which employs a resonant fork structure usually made of alpha quartz as provided in U.S. Pat. No. 4,899,587, U.S. Pat. No. 5,284,059 and U.S. Pat. No. 5,796,002, etc.

Capacitive transducers are also widely used to detect the turning angle of a rotation shaft, such patents include U.S. Pat. No. 3,732,553, U.S. Pat. No. 4,864,295, U.S. Pat. No. 5,099,386, U.S. Pat. No. 5,537,109 and U.S. Pat. No. 6,218,803, etc. A capacitive transducer commonly comprises two stationary capacitive plates and a movable plate mounted on a rotation shaft so that the movable plate can be driven to rotate by the rotation shaft. The movable plate can be conductive or dielectric and is sandwiched between the two stationary plates. The capacitance of the transducer is determined by the rotation position of the movable plate so that the turning angle of the shaft can be detected by measuring the capacitance of the transducer.

Currently, two methods have been usually applied to detect the rotation of the rotor of a motor. One is to apply the magnetic effect related theories and the other is to use optics related theories.

Refer to FIG. 1, a cylindrical magnetic rotor 12 is formed on a motor shaft 10 and a sensor plate 14 is positioned near the magnetic rotor 12. The magnetic rotor 12 may include a plurality of magnetic strips 13 which can produce different magnetic fields. When the magnetic rotor 12 is rotating with the motor shaft 10 synchronously, the sensor plate 14 can detect the rotation thereof by reading the variations of the magnetic fields of the magnetic strips 13 thereof, thereby sending corresponding signals to according means or devices (not shown) for further calculation or control operations.

FIG. 2 gives another similar example. Windings charged with electricity according to pre-set requirements are adopted to produce corresponding magnetic fields. One rotor winding 22 is formed on a resolver rotor 20 of a motor (not shown), and corresponding another winding 23, which is charged with alternating current (AC) and is positioned beside the rotor 20. When the rotor winding 22 is rotated with the motor synchronously, and the winding 23 is charged with AC in the mean time, the rotor winding 22 is thereby caused to produce varying magnetic fields thereof, which will cause a winding assembly 25 beside the rotor 20 to produce according electricity (it may be AC) carrying information of the rotation of the rotor 20, which can be read by some appropriate devices not shown therein.

Another type of conventional device employs a rotating disc on the center shaft of a motor and a permanent magnet fitted around the rotating disc. Thus, the magnet cooperates with a magnetic inductive element to operate together to detect the rotating speed of the motor.

As described in U.S. Pat. No. 6,657,346, a device comprises a motor and a gear case fixed with the motor. A gear is fixed around a shaft of said motor and is engaged with one of a plural of gears contained in an interior space of the gear case. The plural gears in the gear case are engaged with one another, with one of the gears therein connected to a rotating shaft. Two permanent magnets are embedded in one of the plural gears in the gear case and a magnetic inductive element is fixed on a fundamental plate. The fundamental plate together with a base is secured stably in said case body with the magnetic inductive element lying above. The two permanent magnets are embedded in one gear of said plural gears in order to maintain a fixed distance between the magnetic inductive element and the two permanent magnets. A ball effect element is used as the magnetic inductive element and activated by a magnetic field of the N pole and S pole of the two permanent magnets to operate for detecting the rotating speed of the motor.

U.S. Pat. No. 4,626,781 also discloses a device for detecting the speed of rotation and/or an angle of rotation of a shaft and having a motion transmitter which rotates with the shaft. The device thereof comprises a motion transmitter being a magnet, a magnetic-field-dependent sensor receiving signals from the motion transmitter, and a permanent magnet arranged in the vicinity of the sensor with an evaluating circuit which connects with the sensor. The motion transmitter is in the form of a toothed wheel mounted on a shaft to be detected and rotates synchronously with the shaft. The sensor is approached to one tooth of the transmitter and has a strip core with a coil bonded therearound. The strip core is a soft-magnetic alloy and the coil is integrated in the evaluating circuit. The permanent magnet is positioned between the tooth and the strip core, and actually the tooth thereof, the permanent magnet and the sensor lie in one plane in the radial direction of the transmitter. When the transmitter rotates, the tooth as above will move traversely across the magnetic field of the permanent magnet, and since the magnetic field of the permanent magnet couples with that of the sensor, a current will be caused therefrom and will vary according to the traverse movement of the teeth of the transmitter across the magnetic field of the permanent magnet.

Still another type of rotor identifying sensor is available which adopts a so-called rotary encoder method as indicated in U.S. Pat. No. 6,589,15. The rotor has a rotor identification adopter mounted on the bottom of the rotor. The rotor identification adopter has holes and flat surface portions as identification marks at equiangular arranging positions along a circle on the bottom surface of the rotator identification adopter. The centrifugal separator further includes a sensor to generate a detection signal indicating the detected holes and flat portions. The variation of the detection signal provided with rotation of the rotor represents the pattern of the holes. The variation of the detection signal provides the binary code signal with reference to a rotary position from a rotary encoder.

FIGS. 3 and 4 show an example using optical related theories for detecting the rotation of a motor rotor. A disk 32 is fixed on a motor shaft 30 and can rotate with it synchronously. A plurality of slits 33 are formed circumferentially on the disk 32 and approach the edge thereof. A collimating slit 34 is formed next to the circle of slits 33 for providing a reference mark point thereof. A mask 35 is positioned between a light-emitting diode (LED) and the disk 32 and has two slots 37 thereon for letting light beams from the LED go therethrough as well as a collimating slot 38 corresponding to the collimating slit 34 of the disk 32. Correspondent phototransistor means 36 is positioned at a side of the disk 32 opposite to the mask 35 and the LED for reading light beams coming through the according slits 33 of the disk 32.

The arrangement of the LED, the mask 35 and the disk 32 can render that two light beams from the LED are directed to appropriate slits 33 of the disk 32, and then pass therethrough so as to reach the phototransistor means 36. When the disk 32 is rotated together with the motor shaft 30 to a proper position, which makes the collimating slit 34 collimate with the collimating slot 38, the phototransistor means 36 can receive a collimated light beam which makes a reference mark as a beginning point or an end point thereof.

Thus, just as shown in FIGS. 5 and 6, the two light beams through the slots 37 of the mask 35 and the slits 33 of the disk 32 don't reach the phototransistor means 36 at the same time. Instead, the above arrangement thereof makes one beam A lead ahead the other beam B, while the collimation beam I indicates a beginning or an end reference of the rotation of the disk 32, i.e. that of the motor shaft 30.

FIG. 5 shows the digital waveform charts of channel A corresponding to the beam A, channel B corresponding to the beam B, and channel I corresponding to the collimation beam I. The phase difference between the waveform of channel A and the waveform of channel B is 90°. Two half-waves of the channel A or the channel B make a complete wave of the channel I.

Also as shown in FIG. 6 in the mean time, the waveforms of the channel A, the channel B and the channel I are respectively consisted of series of wave crests and troughs which stand for high voltage levels and low voltage levels respectively. Thus, the signal message carried by the channel A, B and/or I can be expressed and transferred in binary codes such as “101010 . . . ”. The S1, S2, S3 and S4 are corresponding to a wave phase of 90° respectively as in FIG. 5, and all of them can consist of an entire wave phase, that is, 360°.

Although the rotary encoder method allows a relatively accurate detection of the rotation of the motor, space and cost for the rotary encoder constructed by the rotation slit disk, the phototransistors, etc. are inevitably increased.

U.S. Pat. No. 4,644,157 provides an optical rotation detecting apparatus for a brushless direct current (DC) motor detects rotation information of the shaft thereof. A plurality slits are arranged at equal pitches along the circumference of a rotary disk. A photoelectric conversion element is arranged circumferetially at a pitch which is an integral multiple of the slit pitch and includes a first set of photoelectric conversion element pieces arranged alternately with the former, thereby generating a first rotation information signal which has a 90-degree phase difference with the first and second rotation information signal. The phases of the first and second rotation information signals are compared with each other to detect the direction of rotation of the shaft. The photoelectric conversion element includes an amorphous silicon photoelectric conversion element.

However, whether the detecting devices using magnetic effects or those using the optic related theories as above discussed, both have to add extra elements such as the magnetic rotor, windings, and the disk with slits thereon, which will inevitably demand additional spaces within the very limited inner space of a motor device thereby resulting in a bulky volume of the motor device.

Moreover, the above-discussed prior arts generally could not offer a very precise detections or measurements of the rotation of a motor rotor. Otherwise, the corresponding detecting devices have to be designed and manufactured very complicated thereby increasing costs thereof adversely.

### SUMMARY OF THE INVENTION

A main object of the present invention is to provide a new detecting device for detecting the rotation of a motor rotor which can achieve precise detection of the rotation of the motor rotor.

A second object of the present invention is to provide a detecting device for detecting the rotation of a motor rotor which do not need to use additional independent element by forming an identification mark means on an integral part of the motor rotor, such as a cylindrical shoulder, thereby being able to achieve a compact structure thereof and reducing costs thereof.

In order to achieve the objects set forth, a detecting device in accordance with the present invention for detecting the rotation of a motor rotor includes a light source, an identification mark means positioned around the motor rotor, and a sensor for detecting the light beams emitted by the light source and coming from the identification mark means.

The light source is positioned beside the identification mark means and the rotor. The sensor is positioned at the same side of the rotor as the light source for receiving the light beams reflected by the identification mark means. The identification mark means can be positioned on a cylindrical shoulder formed around the rotor thereby rotating with the motor rotor synchronously.

Furthermore, the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor. The light source may be a pumped solid state laser.

The identification means may be circumferentially mounted around the outer surface of the cylindrical shoulder axially and may also be positioned on one end face of the cylindrical shoulder in a direction perpendicular to the motor rotor.

The identification mark means may include a plurality of slots formed on the outer surface of the cylindrical shoulder. The slots are arranged in a way that the distances traveled by first light beams emitted by the light source, which reach and are reflected by the bottoms of the slots, are different from the distances traveled by second light beams emitted by the light source, which reach and are reflected by separating portions between adjacent slots which are protuberant compared with the slots.

The traveling distance distinction between an according first reflected light beam and an according second reflected light beam can be a predetermined multiple of the wavelength of the light beams by the light source.

The arrangement of the slots and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

Further, the arrangement of the slots and the separating portions therebetween can ensure that the different traveling distances of the according first reflected light beams and the according second reflected light beams can vary alternately and consecutively, so that the sensor can produce corresponding alternative and consecutive binary code signals, which carry information for calculating and judging the rotation of the motor rotor, by reading the first reflected light beams and the second reflected beams.

Moreover, the arrangement of the slots and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

The identification mark means may include a plurality of convex portions formed on the outer surface of the cylindrical shoulder. The convex portions are arranged in a way that the distances traveled by first light beams emitted by the light source, which reach and are reflected by the convex portions, are different from the distances traveled by second light beams emitted by the light source, which reach and are reflected by separating portions between adjacent convex portions which are lower compared with the convex portions.

The traveling distance distinction between an according first reflected light beam and an according second reflected light beam can be a predetermined multiple of the wavelength of the light beams by the light source.

The arrangement of the convex portions and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

Further, the arrangement of the convex portions and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

Moreover, the arrangement of the convex portions and the separating portions therebetween can ensure that the sensor can produce corresponding alternate and consecutive binary code signals according to predetermined rules, which carry information for calculating and judging the rotation of the motor rotor, by reading the first reflected light beams and the second reflected beams.

The identification mark means can be a colored means.

The colored means can be consisted of a series of consecutive colored portions whose color varies from light to dark, or can be consisted of consecutive colored portions which vary in the aspects of hues, values and/or chromas thereof. The colored means can also be consisted of consecutive colored portions whose colors are different from each other.

The arrangement of the colored means can ensure that the sensor can detect the rotation of the motor rotor by reading the changes of the light beams firstly emitted by the light source and then reflected respectively by corresponding adjacent colored portions of the colored means. The colored portions thereof are arranged so that the reflectivity thereof can vary according to the requirements of the sensor. The colored portions thereof are arranged so that the wavelengths of the reflected light beams by adjacent colored portions can vary according to the requirements of the sensor.

The identification mark means may include a calibration means as a reference mark thereof in the mean time, which is arranged among the identification mark means.

The calibration means can be a calibration slot whose depth is different from the above-mentioned slots of the identification mark means so that the sensor can detect it by reading the unique distance which the reflected light beam reflected by the bottom of the calibration slot travels to reach the sensor.

The calibration means can also be a calibration convex portion so that the sensor can detect it by reading the unique distance which the reflected light beam reflected by the calibration convex portion travels to reach the sensor. The calibration means still can be a calibration portion with a unique color so that the sensor can detect it by comparing the reflected light beam reflected by the calibration portion and other reflected light beams by the slots and the separating portions therebetween in the aspects of reflectivity or wavelength thereof.

Other objects, advantages and novel features of the invention will become more apparent from the following detailed description when taken in conjunction with the accompanying drawings.

### BRIEF DESCRIPTION OF THE DRAWINGS

FIG. 1 is an exploded sketch view illustrating the principle of a first prior art;

FIG. 2 is a sketch view illustrating the principle of a second prior art;

FIG. 3 is an exploded view of a third prior art;

FIG. 4 is an exploded sketch view illustrating the principle of the third prior art;

FIG. 5 is a sketch chart illustrating the output waveforms of the third prior art;

FIG. 6 is a sketch diagram illustrating the output waveforms of the third prior art;

FIG. 7 is a sketch view which is observed from an end face of an identification mark means of a first embodiment in accordance with the present invention;

FIG. 8 is a sketch view which is observed from an end face of an identification mark means of a second embodiment in accordance with the present invention;

FIG. 9 is a sketch view which is observed from an end face of an identification mark means of a third embodiment in accordance with the present invention;

FIG. 10 is a sketch view which is observed from an end face of an identification mark means of a fourth embodiment in accordance with the present invention;

FIG. 11 is a sketch view which is observed from an end face of an identification mark means of a fifth embodiment in accordance with the present invention;

FIG. 12 is a sketch view which is observed from an end face of an identification mark means of a six embodiment in accordance with the present invention;

FIG. 13 is a sketch view which is observed from an end face of an identification mark means of a seventh embodiment in accordance with the present invention;

FIG. 14 is a sketch view which is observed from an end face of an identification mark means of an eighth embodiment in accordance with the present invention;

FIG. 15 is a sketch view which is observed from an end face of an identification mark means of a ninth embodiment in accordance with the present invention;

FIG. 16 is a sketch view which is observed from an end face of an identification mark means of a tenth embodiment in accordance with the present invention;

FIG. 17 is a sketch view which is observed from an end face of an identification mark means of an eleventh embodiment in accordance with the present invention;

FIG. 18 is a sketch view which is observed from an end face of an identification mark means of a twelfth embodiment in accordance with the present invention;

FIG. 19 is a sketch view which is observed from an end face of an identification mark means of a thirteenth embodiment in accordance with the present invention;

FIG. 20 is a sketch view which is observed from an end face of an identification mark means of a fourteenth embodiment in accordance with the present invention;

FIG. 21 is a sketch view which is observed from an end face of an identification mark means of a fifteenth embodiment in accordance with the present invention;

FIG. 22 is a sketch view which is observed from an end face of an identification mark means of a sixteenth embodiment in accordance with the present invention;

FIG. 23 is a perspective view of the first embodiment in accordance with the present invention;

FIG. 24 is a perspective view of the second embodiment in accordance with the present invention;

FIG. 25 is a perspective view of the third embodiment in accordance with the present invention;

FIG. 26 is a perspective view of the fourth embodiment in accordance with the present invention; and

FIG. 27 is a perspective view of the fourteenth embodiment in accordance with the present invention.

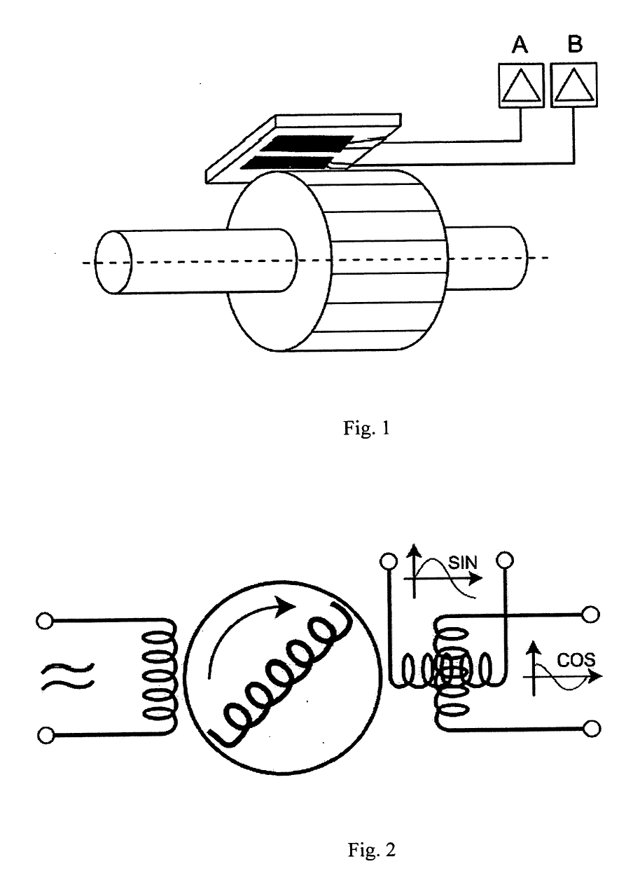

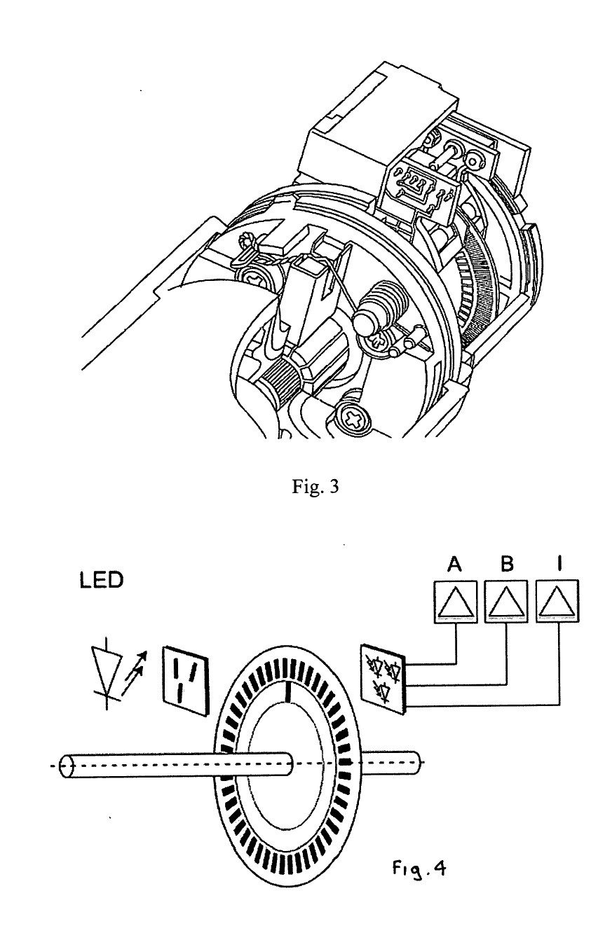

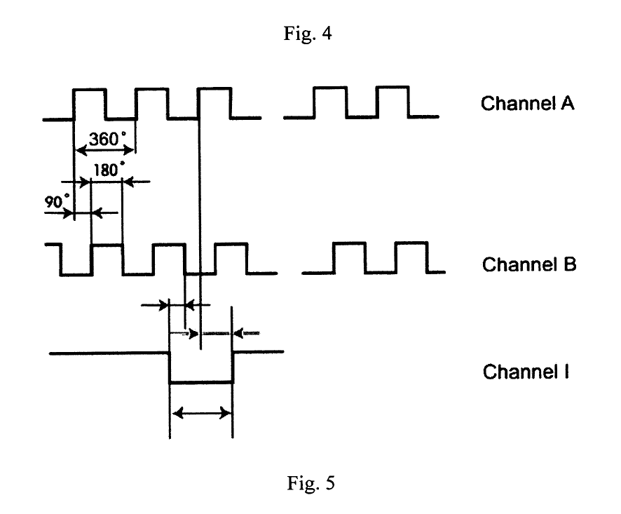

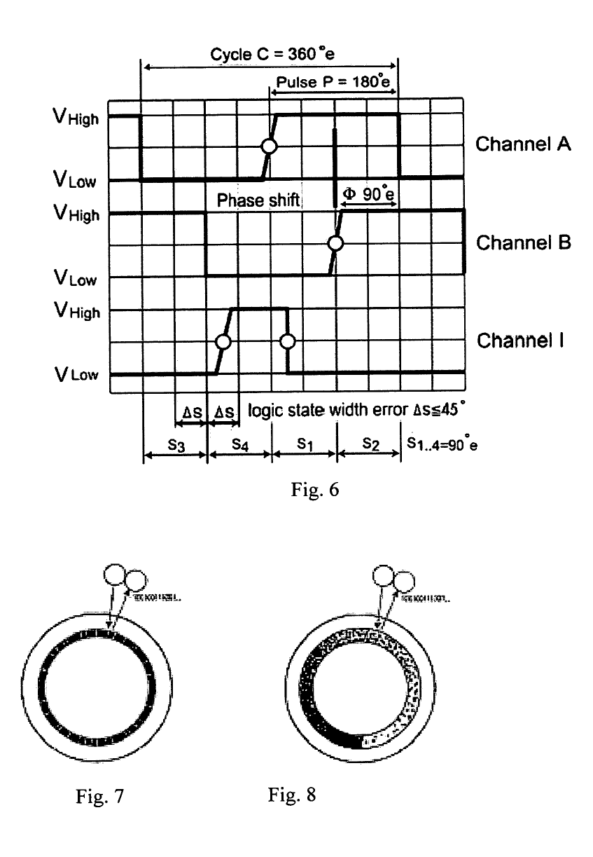

### DETAILED DESCRIPTION OF PREFERRED EMBODIMENT

Referring to FIGS. 7-27, a detecting device 5 in accordance with the present invention for detecting the rotation of a motor rotor 4 includes a light source 7, an identification mark means 6 positioned around the motor rotor 4, and a sensor 8 for detecting the light beams emitted by the light source 7 and coming from the identification mark means 6.

The light source 7 is positioned beside the identification mark means 6 and the rotor 4. The sensor 8 is positioned at the same side of the rotor 4 as the light source 7 for receiving the light beams reflected by the identification mark means 6. The identification mark means 6 can be positioned on a cylindrical shoulder 42 formed around the rotor 4 thereby rotating with the motor rotor 4 synchronously.

Furthermore, the light source 7, such as a LD-pumped solid state laser 7′ as shown in FIGS. 20, 21, 23 and 27, can emit light beams at two different wavelengths, and the sensor 8′ as exampled in these Figures can thus receive and read the light beams with the two different wavelengths respectively reflected from the identification mark means 6 thereby producing according binary code signals carrying more detailed information thereof, whereby the detecting device 5 can achieve very precise detection of the rotation of the motor rotor 4.

The identification mark means 6 may be circumferentially mounted around the outer surface of the cylindrical shoulder 42 axially and may also be positioned on one end face of the cylindrical shoulder 42 in a direction perpendicular to the motor rotor 4.

Referring to FIG. 7, a first embodiment in accordance with the present invention is shown. The identification mark means 6 of the first embodiment may include a plurality of slots 610 formed on the outer surface of the cylindrical shoulder 42 of the motor rotor 4.

The slots 610 are arranged in a way that the distances traveled by first light beams emitted by the light source 7 with reference to FIG. 23 in the mean time, which reach and are reflected by the bottoms of the slots 610, are different from the distances traveled by second light beams emitted by the light source 7, which reach and are reflected by separating portions (not labeled) between adjacent slots 610 which are protuberant compared with the slots 610.

The traveling distance distinction between an according first reflected light beam and an according second reflected light beam can be a predetermined multiple of the wavelength of the light beams by the light source. The multiple can be predetermined according to the actual requirements of the sensor 8 in different circumstances thereof.

The arrangement of the slots 610 and the separating portions therebetween can ensure that the different traveling distances of the according first reflected light beams and the according second reflected light beams can vary consecutively, so that the sensor 8 can produce corresponding consecutive binary code signals like “111000 . . . ”, which carry information for calculating and judging the rotation of the motor rotor, by reading the first reflected light beams and the second reflected beams.

Furthermore, the arrangement of the slots and the separating portions therebetween should ensure that the different traveling distances of the according first reflected light beams and the according second reflected light beams can vary alternately and consecutively, so that the sensor can produce corresponding alternative and consecutive binary code signals such as “010101 . . . ”, which carry information for calculating and judging the rotation of the motor rotor, by reading the first reflected light beams and the second reflected beams.

On the other hand, the arrangement of the slots 610 and the separating portions therebetween should also be able to ensure that the sensor 8 can produce corresponding alternate and consecutive binary code signals “10110001101 . . . ” according to predetermined rules thereof, which carry information for calculating and judging the rotation of the motor rotor, by reading the first reflected light beams and the second reflected beams.

FIGS. 8 and 24 show a second embodiment of the present invention. The identification mark means 6 of the detecting device 5 may include a plurality of convex portions 612 formed on the outer surface of the cylindrical shoulder 42.

The convex portions 612 are arranged in a way that the distances traveled by first light beams emitted by the light source, which reach and are reflected by the convex portions 612, are different from the distances traveled by second light beams emitted by the light source 7, which reach and are reflected by separating portions (not labeled) between adjacent convex portions 612, which are lower compared with the convex portions 612.

The traveling distance distinction between an according first reflected light beam and an according second reflected light beam can be a predetermined multiple of the wavelength of the light beams by the light source 7, which is substantially the same with that of the first embodiment.

The arrangement of the convex portions 612 and the separating portions therebetween should satisfy substantially the same requirements or rules as those of the first embodiment as discussed above. Hence, detailed descriptions are omitted herewith.

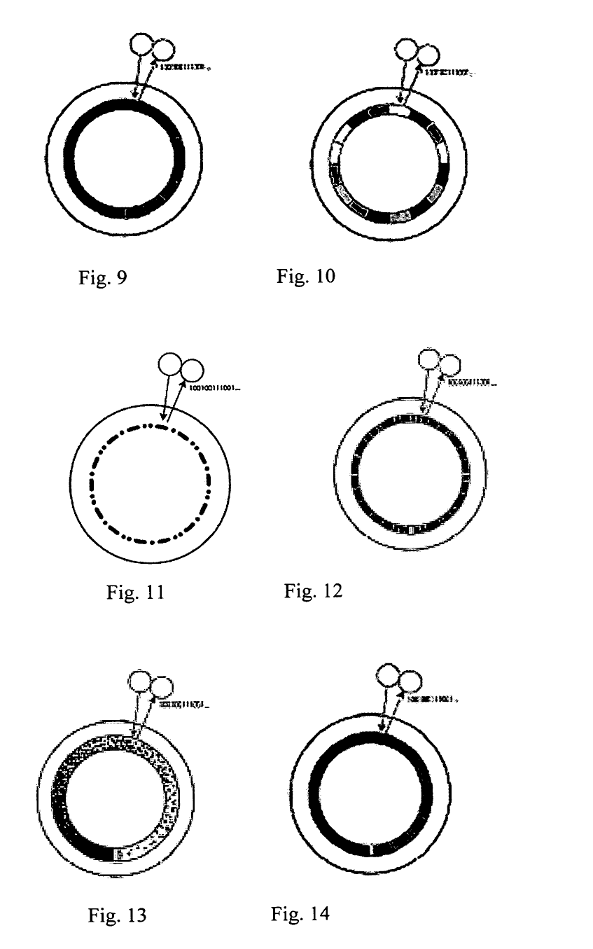

The identification mark means 6 also can be a colored means 620 as shown in FIGS. 9 and 10 respectively.

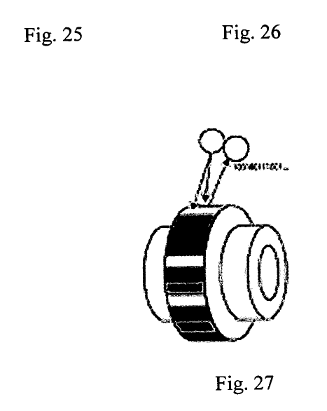

In a third embodiment in accordance with the present invention as shown in FIGS. 9 and 25, the colored means 620 can be consisted of a series of consecutive colored portions 622 whose color varies from light to dark. The specific color of the colored portions 622 may be green or yellow, or other appropriate color as desired.

The arrangement of the colored means 620 should ensure that the sensor 8 can detect the rotation of the motor rotor 4 by reading the changes of the light beams firstly emitted by the light source 7 and then reflected respectively by corresponding adjacent colored portions 622 of the colored means 620.

For example, the colored portions 622 thereof are arranged so that the reflectivity thereof can vary according to the requirements of the sensor 8. The colored portions 622 can alternatively be arranged so that the wavelengths of the reflected light beams by adjacent colored portions 622 can vary according to the requirements of the sensor 8.

The colored means 620 can be consisted of consecutive colored portions 625 whose colors are different from each other as shown in a fourth embodiment thereof in FIGS. 10 and 26.

The arrangement of the colored means 620 here in the fourth embodiment is substantially the same with that of the third embodiment thereby omitting according details herewith.

FIG. 11 shows a fifth embodiment of the present invention. The identification means 6 is arranged in a combination of slots 630, convex portions 632 and separation portions 635 therebetween.

Essentially, the arrangement of the identification means 6 in this fifth embodiment is very similar to that of the first and second embodiments as clarified above. The traveling distance distinction between an according first reflected light beam by the slots 630, an according second reflected light beam by the convex portions 632, and an according third reflected light beam by the separating portions 635 can be a predetermined multiple of the wavelength of the light beams by the light source respectively. The multiple can be predetermined according to the actual requirements of the sensor 8 in different circumstances thereof.

The arrangement of the slots 630, convex portions 632 and the separating portions 635 can ensure that the different traveling distances of the according first reflected light beams, the according second reflected light beams and the according third reflected light beams can vary consecutively, so that the sensor 8 can produce corresponding consecutive binary code signals like “11100010 . . . ”, which carry information for calculating and judging the rotation of the motor rotor, by reading the first reflected light beams and the second reflected beams.

Furthermore, the arrangement of the slots 630, the convex portions 632 and the separating portions 635 should ensure that the different traveling distances of the according first reflected light beams, the according second reflected light beams and the according third reflected light beams can vary alternately and consecutively as predetermined, so that the sensor can produce corresponding alternative and consecutive binary code signals such as “010101 . . . ”, which carry information for calculating and judging the rotation of the motor rotor 4, by reading the first reflected light beams and the second reflected beams.

The identification mark means 6, as in the sixth, seventh, eighth and ninth embodiments respectively in FIGS. 12, 13, 14 and 15, includes a calibration means 65 as a reference mark thereof.

In the sixth embodiment, the identification mark means 6 includes the 8 calibration means 65 and a plurality of slots 610 circumferentially formed on the outer surface of the cylindrical shoulder 42 of the motor rotor 4.

The calibration means 65 is arranged among the slots 610.

The calibration means 65 can be a calibration slot whose depth is different from the slots 610 so that the sensor 8 can detect it by reading the unique distance which the reflected light beam reflected by the bottom of the calibration slot travels to reach the sensor.

The calibration means 65 can be a calibration convex portion so that the sensor 8 can detect it by reading the unique distance which the reflected light beam reflected by the calibration convex portion travels to reach the sensor 8.

The calibration means 65 can be a calibration portion with a unique color so that the sensor 8 can detect it by comparing the reflected light beam reflected by the calibration portion and other reflected light beams by the slots 610 and the separating portions therebetween in the aspects of reflectivity or wavelength thereof.

The arrangement of the slots 610 should satisfy substantially the same requirements as explained above in the first embodiment and other former embodiments.

In the seventh embodiment as in FIG. 13, the identification mark means 6 includes a calibration means 65 as a reference mark thereof and a plurality of convex portions 612 circumferentially formed on the outer surface of the cylindrical shoulder 42 of the motor rotor 4.

The calibration means 65 is arranged among the convex portions 612. Other requirements regarding the calibration means 65 and the arrangement of the convex portions are essentially the same with the seventh embodiment and the former embodiments thereof.

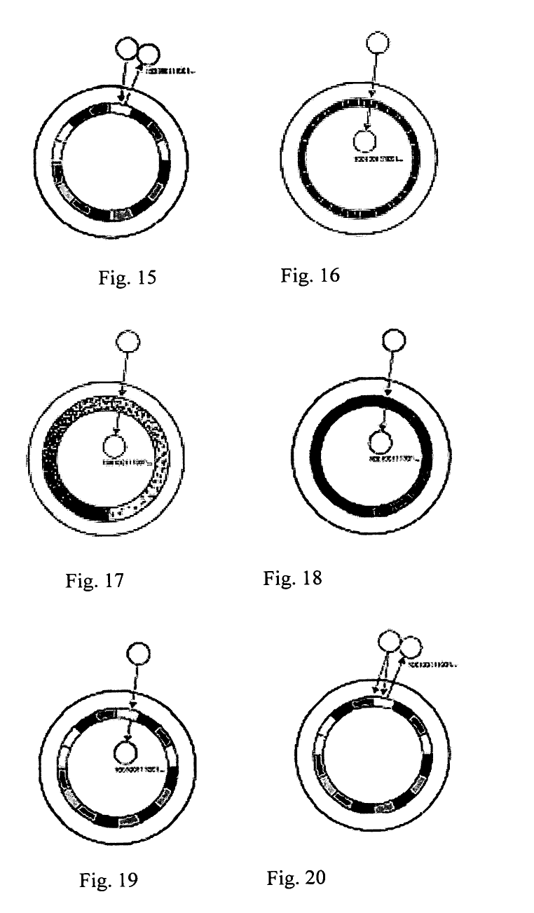

In the eighth and ninth embodiments as shown in FIGS. 14 and 15, the identification mark means 6 has a circumferential colored means 620 and a calibration means 65 as a reference mark thereof.

In the eighth embodiment as in FIG. 14, the colored means 620 can be consisted of a series of consecutive colored portions 622 whose color varies from light to dark. The arrangement of the colored means 620 is substantially the same with that of the third embodiment in FIG. 9. The calibration means is arranged among the colored portions 622 of the colored means 620. Other relative requirements regarding the calibration means 65 please refer to the pertinent content of the correspondent former embodiments.

As to the ninth embodiment as in FIG. 15, the colored means 620 is consisted of consecutive colored portions which vary in the aspects of hues, values and/or chromas thereof. Other arrangements thereof are substantially the same with the eighth embodiment.

In another tenth to thirteenth embodiments as shown in FIGS. 16 to 19, the identification mark means 6 is made of some proper partially transparent materials. The sensor 8 is thus positioned in an interior space of the motor rotor 4.

The tenth, eleventh, twelfth and thirteenth embodiments are generally the same with the first, second, third and fourth embodiments respectively, except that the identification mark means 6 is partially transparent and the sensor is positioned in the interior space of the motor rotor 4. Hence, the sensor 8 reads the changes of the light beams which come through the partially transparent identification mark means 6. The changes may be the intensity changes or wavelength changes. For the latter, the identification mark means 6 may absorb certain light beams with one or more specific wavelength, or cause the light beams to occur some other kind of changes after passing therethrough.

In the fourteenth, fifteenth and sixteenth embodiments as shown in FIGS. 20, 21 and 22, the light source 7′ can emit two light beams with different wavelengths. The sensor 8′ can thus receive and read the two light beams with different wavelengths respectively reflected from the identification mark means 6 as in the fourteenth and fifteenth embodiments shown in FIGS. 20 and 21, thereby producing according binary code signals carrying more detailed information thereof. Hence, the detecting device 5 can achieve very precise detection of the rotation of the motor rotor 4. The light source 7′ of these embodiments may be a laser diode, particularly a pumped solid state laser.

Also refer to FIG. 27, the design of the fourteen embodiment is very similar to the fourth embodiment except that it uses the light source 7′ which can emit two light beams with different wavelengths, and the sensor 8′ is able to detect the changes of the two light beams with different wavelengths after they pass through the identification mark means 6. Hence, other necessary and possible arrangement of the detecting device 5 in this embodiment can refer to the previous fourth embodiment.

The main difference between the fifteenth embodiment in FIG. 21 and the fourteenth embodiment in FIG. 20 is that a calibration means 65 is arranged among the identification means 6. And, the arrangement of the calibration means 65 can refer to pertinent contents of the previous embodiments as disclosed above.

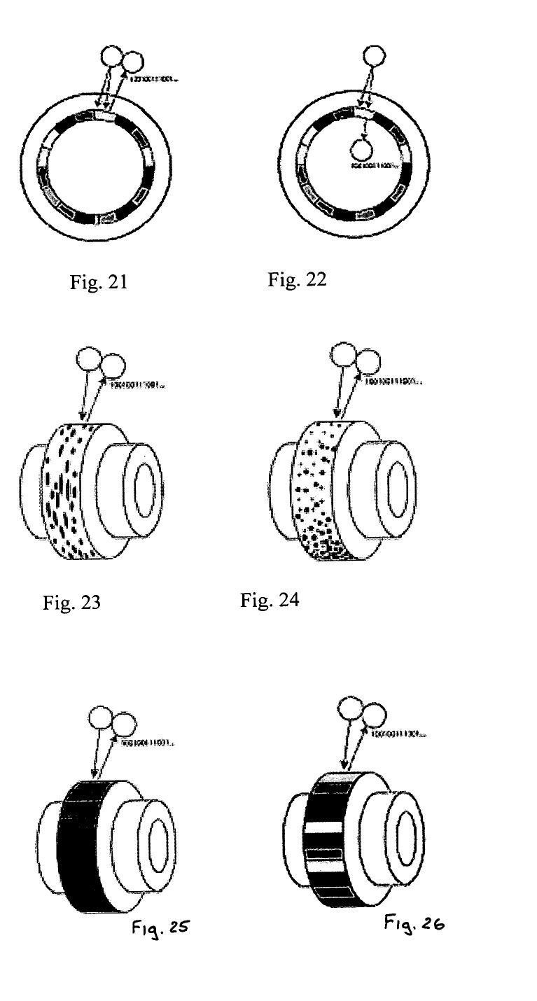

What the sixteenth embodiment as shown in FIG. 22 is different from the fourteenth and fifteenth embodiments, mainly lies in that the identification means 6 is partially transparent as substantially the same with that of the above thirteenth embodiment.

A Charge-Coupled Device (CCD) or a Complementary Metal Oxide Semiconductor (CMOS) can also be used to implement the present invention.

As well known, an additional light source is not very necessary to the CCD or CMOS device for catching the image of an aimed object. Ambient light is enough for it to get and identify images of a specific object.

Hence, a CCD or CMOS device may used to detect the changes of the light beams reflected by the identification mark means 6 in accordance with the present invention when the identification mark means 6 is rotating with the rotor 4 synchronously. So, a CCD or CMOS device can act as the sensor 8 of the present invention and the light source 7. The CCD or CMOS device can be positioned beside the rotor 4.

The shield for enclosing the rotor 4 may have some openings thereon so that the interior thereof may have enough light for the CCD or CMOS to get and identify the identification means 6, thereby detecting the rotation of the identification mark means 6 and the rotor 4. Or, if the interior ambient light is enough, even the openings are not necessary to be formed on the shield of the rotor 4. Therefore, the CCD or CMOS may be applied to the above-discussed embodiments by simply replacing the sensor 8, or the sensor 8 and the light source 7.

Further, in theory, other available photographic devices may also be applied to replace the sensor 8, or the sensor 9 and the light source 7 of the present invention just as the above-mentioned CCD or CMOS device in similar way.

Optionally, the sensor 8 and the light source 7, or the CCD or CMOS device, may be positioned on the rotor 4 while the identification mark means 6 can then be positioned beside the rotor 4. Thus, the light beams are firstly emitted by the light source 7 to the identification mark means 6 and then come back from the identification mark means 6 to the sensor 8.

As the light source 7 and the sensor 8 is synchronously rotated with the rotor 4 while the identification mark means 6 remains relatively stationary, the sensor 8 can then detect the changes of the light beams coming from the identification mark means 6 since the identification mark means 6 are essentially the same with the above discussed whereby additional descriptions thereof are omitted herewith. Similarly, other conditions of this case are also substantially the same with the above embodiments in accordance with the present invention and therefore are omitted herewith.

On the other hand, since the CCD or CMOS device 8 can directly detect the images of the identification means 6, the identification means may thus comprise a series of identification portions (such as colored portions, slots, or convex portions and so on) which are arranged randomly instead of being pre-arranged according to the requirements of the proper interior circuits of the CCD or CMOS device.

Before the detecting device is used, the sensor 8 (CCD or CMOS device, etc.) should firstly detect the whole image of the identification means 6 so as to set up a comparative model. For example, the identification means 6 may be made to rotate circumferentially in front of the sensor 8, so that the sensor 8 can detect a whole image of the identification means 6. When in use, the sensor 8 can thus take the detected whole image as a comparative model for calculating the corresponding rotating angles of the identification means 6 by detecting changes of the light beams coming from the identification means 6.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A detecting device for detecting the rotation of a motor rotor comprises a light source, an identification mark means, and a sensor for detecting the light beams emitted by the light source and coming from the identification mark means.

2. The detecting device for detecting the rotation of a motor rotor as claimed in claim 1, wherein the light source is positioned beside the identification mark means and the rotor.

3. The detecting device for detecting the rotation of a motor rotor as claimed in claim 2, wherein the sensor is positioned at the same side of the rotor as the light source for receiving the light beams reflected by the identification mark means.

4. The detecting device for detecting the rotation of a motor rotor as claimed in claim 3, wherein the identification mark means can be positioned on a cylindrical shoulder formed around the rotor thereby rotating with the motor rotor synchronously.

5. The detecting device for detecting the rotation of a motor rotor as claimed in claim 4, wherein the identification mark means may be circumferentially mounted around the outer surface of the cylindrical shoulder axially.

6. The detecting device for detecting the rotation of a motor rotor as claimed in claim 4, wherein the identification means may be positioned on one end face of the cylindrical shoulder in a direction perpendicular to the motor rotor.

7. The detecting device for detecting the rotation of a motor rotor as claimed in claims 5 or 6, wherein the identification mark means may include a plurality of slots formed on the cylindrical shoulder.

8. The detecting device for detecting the rotation of a motor rotor as claimed in claim 7, wherein the slots are arranged in a way that the distances traveled by first light beams emitted by the light source, which reach and are reflected by the bottoms of the slots, are different from the distances traveled by second light beams emitted by the light source, which reach and are reflected by separating portions between adjacent slots which are protuberant compared with the slots.

9. The detecting device for detecting the rotation of a motor rotor as claimed in claim 8, wherein the traveling distance distinction between an according first reflected light beam and an according second reflected light beam can be a predetermined multiple of the wavelength of the light beams by the light source.

10. The detecting device for detecting the rotation of a motor rotor as claimed in claim 9, wherein the arrangement of the slots and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

11. The detecting device for detecting the rotation of a motor rotor as claimed in claim 10, wherein the arrangement of the slots and the separating portions therebetween can ensure that the different traveling distances of the according first reflected light beams and the according second reflected light beams can vary alternately and consecutively, so that the sensor can produce corresponding alternative and consecutive binary code signals, which carry information for calculating and judging the rotation of the motor rotor, by reading the first reflected light beams and the second reflected beams.

12. The detecting device for detecting the rotation of a motor rotor as claimed in claim 11, wherein the arrangement of the slots and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

13. The detecting device for detecting the rotation of a motor rotor as claimed in claim 12, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

14. The detecting device for detecting the rotation of a motor rotor as claimed in claims 5 or 6, wherein the identification mark means may include a plurality of convex portions formed on the cylindrical shoulder.

15. The detecting device for detecting the rotation of a motor rotor as claimed in claim 14, wherein the convex portions are arranged in a way that the distances traveled by first light beams emitted by the light source, which reach and are reflected by the convex portions, are different from the distances traveled by second light beams emitted by the light source, which reach and are reflected by separating portions between adjacent convex portions which are lower compared with the convex portions.

16. The detecting device for detecting the rotation of a motor rotor as claimed in claim 15, wherein the traveling distance distinction between an according first reflected light beam and an according second reflected light beam can be a predetermined multiple of the wavelength of the light beams by the light source.

17. The detecting device for detecting the rotation of a motor rotor as claimed in claim 16, wherein the arrangement of the convex portions and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

18. The detecting device for detecting the rotation of a motor rotor as claimed in claim 17, wherein the arrangement of the convex portions and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

19. The detecting device for detecting the rotation of a motor rotor as claimed in claim 18, wherein the arrangement of the convex portions and the separating portions therebetween can ensure that the sensor can produce corresponding alternate and consecutive binary code signals according to predetermined rules, which carry information for calculating and judging the rotation of the motor rotor, by reading the first reflected light beams and the second reflected beams.

20. The detecting device for detecting the rotation of a motor rotor as claimed in claim 19, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

21. The detecting device for detecting the rotation of a motor rotor as claimed in claims 5 or 6, wherein the identification mark means can be a colored means.

22. The detecting device for detecting the rotation of a motor rotor as claimed in claim 21, wherein the colored means can be consisted of a series of consecutive colored portions whose color varies from light to dark.

23. The detecting device for detecting the rotation of a motor rotor as claimed in claim 22, wherein the arrangement of the colored means can ensure that the sensor can detect the rotation of the motor rotor by reading the changes of the light beams firstly emitted by the light source and then reflected respectively by corresponding adjacent colored portions of the colored means.

24. The detecting device for detecting the rotation of a motor rotor as claimed in claim 23, wherein the colored portions thereof are arranged so that the reflectivity thereof can vary according to the requirements of the sensor.

25. The detecting device for detecting the rotation of a motor rotor as claimed in claim 24, wherein the colored portions thereof are arranged so that the wavelengths of the reflected light beams by adjacent colored portions can vary according to the requirements of the sensor.

26. The detecting device for detecting the rotation of a motor rotor as claimed in claim 25, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

27. The detecting device for detecting the rotation of a motor rotor as claimed in claim 21, wherein the colored means can be consisted of consecutive colored portions which vary in the aspects of hues, values and/or chromas thereof.

28. The detecting device for detecting the rotation of a motor rotor as claimed in claim 27, wherein the arrangement of the colored means can ensure that the sensor can detect the rotation of the motor rotor by reading the changes of the reflected light beams firstly emitted by the light source and then reflected respectively by corresponding adjacent colored portions of the colored means.

29. The detecting device for detecting the rotation of a motor rotor as claimed in claim 28, wherein the colored portions thereof are arranged so that the reflectivity thereof can vary according to the requirements of the sensor.

30. The detecting device for detecting the rotation of a motor rotor as claimed in claim 29, wherein the colored portions thereof are arranged so that the wavelengths of the reflected light beams by adjacent colored portions can vary according to the requirements of the sensor.

31. The detecting device for detecting the rotation of a motor rotor as claimed in claim 30, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

32. The detecting device for detecting the rotation of a motor rotor as claimed in claim 21, wherein the colored means can be consisted of consecutive colored portions whose colors are different from each other.

33. The detecting device for detecting the rotation of a motor rotor as claimed in claim 32, wherein the arrangement of the colored means can ensure that the sensor can detect the rotation of the motor rotor by reading the changes of the light beams firstly emitted by the light source and then reflected respectively by corresponding adjacent colored portions of the colored means.

34. The detecting device for detecting the rotation of a motor rotor as claimed in claim 33, wherein the colored portions thereof are arranged so that the reflectivity thereof can vary according to the requirements of the sensor.

35. The detecting device for detecting the rotation of a motor rotor as claimed in claim 34, wherein the colored portions thereof are arranged so that the wavelengths of the reflected light beams by adjacent colored portions can vary according to the requirements of the sensor.

36. The detecting device for detecting the rotation of a motor rotor as claimed in claim 35, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve precise detection of the rotation of the motor rotor.

37. The detecting device for detecting the rotation of a motor rotor as claimed in claim 5 or 6, wherein the identification mark means may include a calibration means as a reference mark thereof, and a plurality of slots circumferentially formed on the outer surface of the cylindrical shoulder.

38. The detecting device for detecting the rotation of a motor rotor as claimed in claim 37, wherein the slots are arranged in a way that the distances traveled by first light beams emitted by the light source, which reach and are reflected by the bottoms of the slots, are different from the distances traveled by second light beams emitted by the light source, which reach and are reflected by separating portions between adjacent slots which are protuberant compared with the slots.

39. The detecting device for detecting the rotation of a motor rotor as claimed in claim 38, wherein the traveling distance distinction between an according first reflected light beams and an according second reflected light beams can be a predetermined multiple of the wavelength of the light beams by the light source.

40. The detecting device for detecting the rotation of a motor rotor as claimed in claim 39, wherein the arrangement of the slots and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

41. The detecting device for detecting the rotation of a motor rotor as claimed in claim 40, wherein the arrangement of the slots and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

42. The detecting device for detecting the rotation of a motor rotor as claimed in claim 41, wherein the arrangement of the slots and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

43. The detecting device for detecting the rotation of a motor rotor as claimed in claim 42, wherein the calibration means is arranged among the slots.

44. The detecting device for detecting the rotation of a motor rotor as claimed in claim 43, wherein the calibration means can be a calibration slot whose depth is different from the above slots so that the sensor can detect it by reading the unique distance which the reflected light beam reflected by the bottom of the calibration slot travels to reach the sensor.

45. The detecting device for detecting the rotation of a motor rotor as claimed in claim 43, wherein the calibration means can be a calibration convex portion so that the sensor can detect it by reading the unique distance which the reflected light beam reflected by the calibration convex portion travels to reach the sensor.

46. The detecting device for detecting the rotation of a motor rotor as claimed in claim 43, wherein the calibration means can be a calibration portion with a unique color so that the sensor can detect it by comparing the reflected light beam reflected by the calibration portion and other reflected light beams by the slots and the separating portions therebetween in the aspects of reflectivity or wavelength thereof.

47. The detecting device for detecting the rotation of a motor rotor as claimed in claim 46, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

48. The detecting device for detecting the rotation of a motor rotor as claimed in claims 5 or 6, wherein the identification mark means may include a calibration means as a reference mark thereof and a plurality of convex portions circumferentially formed on the outer surface of the cylindrical shoulder.

49. The detecting device for detecting the rotation of a motor rotor as claimed in claim 48, wherein the convex portions are arranged in a way that the distances traveled by first light beams emitted by the light source, which reach and are reflected by the convex portions, are different from the distances traveled by second light beams emitted by the light source, which reach and are reflected by separating portions between adjacent convex portions which are lower compared with the convex portions.

50. The detecting device for detecting the rotation of a motor rotor as claimed in claim 49, wherein the traveling distance distinction between an according first reflected light beam and an according second reflected light beam can be a predetermined multiple of the wavelength of the light beams by the light source.

51. The detecting device for detecting the rotation of a motor rotor as claimed in claim 50, wherein the arrangement of the convex portions and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

52. The detecting device for detecting the rotation of a motor rotor as claimed in claim 51, wherein the arrangement of the convex portions and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

53. The detecting device for detecting the rotation of a motor rotor as claimed in claim 52, wherein the arrangement of the convex portions and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

54. The detecting device for detecting the rotation of a motor rotor as claimed in claim 53, wherein the calibration means is arranged among the convex portions.

55. The detecting device for detecting the rotation of a motor rotor as claimed in claim 54, wherein the calibration means can be a calibration slot so that the sensor can detect it by reading the unique distance which the reflected light beam reflected by the bottom of the calibration slot travels to reach the sensor.

56. The detecting device for detecting the rotation of a motor rotor as claimed in claim 54, wherein the calibration means can be a calibration convex portion whose height is different from the above convex portions so that the sensor can detect it by reading the unique distance which the reflected light beam reflected by the calibration convex portion travels to reach the sensor.

57. The detecting device for detecting the rotation of a motor rotor as claimed in claim 54, wherein the calibration means can be a calibration portion with a unique color so that the sensor can detect it by comparing the reflected light beam reflected by the calibration portion and other reflected light beams by the convex portions and the separating portions therebetween in the aspect of reflectivity or wavelength thereof.

58. The detecting device for detecting the rotation of a motor rotor as claimed in claim 57, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

59. The detecting device for detecting the rotation of a motor rotor as claimed in claims 5 or 6, wherein the identification mark means includes a circumferential colored means and a calibration means as a reference mark thereof.

60. The detecting device for detecting the rotation of a motor rotor as claimed in claim 59, wherein the colored means can be consisted of a series of consecutive colored portions whose color varies from light to dark.

61. The detecting device for detecting the rotation of a motor rotor as claimed in claim 60, wherein the arrangement of the colored means can ensure that the sensor can detect the rotation of the motor rotor by reading the changes of the light beams firstly emitted by the light source and then reflected respectively by corresponding adjacent colored portions of the colored means.

62. The detecting device for detecting the rotation of a motor rotor as claimed in claim 61, wherein the colored portions thereof are arranged so that the reflectivity thereof can vary according to the requirements of the sensor.

63. The detecting device for detecting the rotation of a motor rotor as claimed in claim 62, wherein the colored portions thereof are arranged so that the wavelengths of the reflected light beams by adjacent colored portions can vary according to the requirements of the sensor.

64. The detecting device for detecting the rotation of a motor rotor as claimed in claim 63, wherein the calibration means is arranged among the colored portions.

65. The detecting device for detecting the rotation of a motor rotor as claimed in claim 64, wherein the calibration means can be a calibration slot so that the sensor can detect it by reading the unique distance which the reflected light beam reflected by the bottom of the calibration slot travels to reach the sensor.

66. The detecting device for detecting the rotation of a motor rotor as claimed in claim 64, wherein the calibration means can be a calibration convex portion so that the sensor can detect it by reading the unique distance which the reflected light beam reflected by the calibration convex portion travels to reach the sensor.

67. The detecting device for detecting the rotation of a motor rotor as claimed in claim 64, wherein the calibration means can be a calibration portion with a unique color different from those of the colored portions above so that the sensor can detect it by comparing the reflected light beam reflected by the calibration portion and other reflected light beams by the other colored portions in the aspects of reflectivity or wavelength thereof.

68. The detecting device for detecting the rotation of a motor rotor as claimed in claim 64, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

69. The detecting device for detecting the rotation of a motor rotor as claimed in claim 59, wherein the colored means can be consisted of consecutive colored portions which vary in the aspects of hues, values and/or chromas thereof.

70. The detecting device for detecting the rotation of a motor rotor as claimed in claim 69, wherein the arrangement of the colored means can ensure that the sensor can detect the rotation of the motor rotor by reading the changes of the reflected light beams firstly emitted by the light source and then reflected respectively by corresponding adjacent colored portions of the colored means.

71. The detecting device for detecting the rotation of a motor rotor as claimed in claim 70, wherein the colored portions thereof are arranged so that the reflectivity thereof can vary according to the requirements of the sensor.

72. The detecting device for detecting the rotation of a motor rotor as claimed in claim 71, wherein the colored portions thereof are arranged so that the wavelengths of the reflected light beams by adjacent colored portions can vary according to the requirements of the sensor.

73. The detecting device for detecting the rotation of a motor rotor as claimed in claim 72, wherein the calibration means is arranged among the colored portions.

74. The detecting device for detecting the rotation of a motor rotor as claimed in claim 73, wherein the calibration means can be a calibration slot whose depth is different from the colored portions so that the sensor can detect it by reading the unique distance which the reflected light beam reflected by the colored portions travels to reach the sensor.

75. The detecting device for detecting the rotation of a motor rotor as claimed in claim 73, wherein the calibration means can be a calibration convex portion so that the sensor can detect it by reading the unique distance which the reflected light beam reflected by the calibration convex portion travels to reach the sensor.

76. The detecting device for detecting the rotation of a motor rotor as claimed in claim 73, wherein the calibration means can be a calibration portion with a unique color so that the sensor can detect it by comparing the reflected light beam reflected by the calibration portion and other reflected light beams by the colored portions in the aspects of reflectivity or wavelength thereof.

77. The detecting device for detecting the rotation of a motor rotor as claimed in claim 73, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

78. The detecting device for detecting the rotation of a motor rotor as claimed in claim 59, wherein the colored means can be consisted of consecutive colored portions whose colors are different from each other.

79. The detecting device for detecting the rotation of a motor rotor as claimed in claim 78, wherein the arrangement of the colored means can ensure that the sensor can detect the rotation of the motor rotor by reading the changes of the light beams firstly emitted by the light source and then reflected respectively by corresponding adjacent colored portions of the colored means.

80. The detecting device for detecting the rotation of a motor rotor as claimed in claim 79, wherein the colored portions thereof are arranged so that the reflectivity thereof can vary according to the requirements of the sensor.

81. The detecting device for detecting the rotation of a motor rotor as claimed in claim 80, wherein the colored portions thereof are arranged so that the wavelengths of the reflected light beams by adjacent colored portions can vary according to the requirements of the sensor.

82. The detecting device for detecting the rotation of a motor rotor as claimed in claim 81, wherein the calibration means is arranged among the colored portions.

83. The detecting device for detecting the rotation of a motor rotor as claimed in claim 82, wherein the calibration means can be a calibration slot whose depth is different from the above slots so that the sensor can detect it by reading the unique distance which the reflected light beam reflected by the bottom of the calibration slot travels to reach the sensor.

84. The detecting device for detecting the rotation of a motor rotor as claimed in claim 82, wherein the calibration means can be a calibration convex portion so that the sensor can detect it by reading the unique distance which the reflected light beam reflected by the calibration convex portion travels to reach the sensor.

85. The detecting device for detecting the rotation of a motor rotor as claimed in claim 82, wherein the calibration means can be a calibration portion with a unique color so that the sensor can detect it by comparing the reflected light beam reflected by the calibration portion and other reflected light beams by the colored portions in the aspects of reflectivity or wavelength thereof.

86. The detecting device for detecting the rotation of a motor rotor as claimed in claim 82, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

87. The detecting device for detecting the rotation of a motor rotor as claimed in claim 2, wherein the sensor is positioned at the other interior side of the rotor opposite to the light source for receiving the light beams coming through the identification mark means.

88. The detecting device for detecting the rotation of a motor rotor as claimed in claim 87, wherein the identification mark means is made of a partially transparent material.

89. The detecting device for detecting the rotation of a motor rotor as claimed in claim 88, wherein the identification mark means can be positioned on a cylindrical shoulder formed around the rotor thereby rotating with the motor rotor synchronously.

90. The detecting device for detecting the rotation of a motor rotor as claimed in claim 89, wherein the identification means may be circumferentially mounted around the outer surface of the cylindrical shoulder axially.

91. The detecting device for detecting the rotation of a motor rotor as claimed in claim 89, wherein the identification means may be positioned on one end face of the cylindrical shoulder in a direction perpendicular to the motor rotor.

92. The detecting device for detecting the rotation of a motor rotor as claimed in claim 90 or 91, wherein the identification mark means may include a plurality of slots formed on the cylindrical shoulder.

93. The detecting device for detecting the rotation of a motor rotor as claimed in claim 92, wherein the slots are arranged in a way that the distances traveled by first light beams emitted by the light source, which reach and are reflected by the bottoms of the slots, are different from the distances traveled by second light beams emitted by the light source, which reach and are reflected by separating portions between adjacent slots which are protuberant compared with the slots.

94. The detecting device for detecting the rotation of a motor rotor as claimed in claim 93, wherein the traveling distance distinction between the according first reflected light beams and the according second reflected light beams can be a predetermined multiple of the wavelength of the light beams by the light source.

95. The detecting device for detecting the rotation of a motor rotor as claimed in claim 94, wherein the arrangement of the slots and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

96. The detecting device for detecting the rotation of a motor rotor as claimed in claim 95, wherein the arrangement of the slots and the separating portions therebetween can ensure that the different traveling distances of the according first reflected light beams and the according second reflected light beams can vary alternately and consecutively, so that the sensor can produce corresponding alternative and consecutive binary code signals, which carry information for calculating and judging the rotation of the motor rotor, by reading the first reflected light beams and the second reflected beams.

97. The detecting device for detecting the rotation of a motor rotor as claimed in claim 96, wherein the arrangement of the slots and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

98. The detecting device for detecting the rotation of a motor rotor as claimed in claim 97, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

99. The detecting device for detecting the rotation of a motor rotor as claimed in claims 90 or 91, wherein the identification mark means may include a plurality of convex portions formed on the outer surface of the cylindrical shoulder.

100. The detecting device for detecting the rotation of a motor rotor as claimed in claim 99, wherein the convex portions are arranged in a way that the distances traveled by first light beams emitted by the light source, which reach and are reflected by the convex portions, are different from the distances traveled by second light beams emitted by the light source, which reach and are reflected by separating portions between adjacent convex portions which are lower compared with the convex portions.

101. The detecting device for detecting the rotation of a motor rotor as claimed in claim 100, wherein the traveling distance distinction between an according first reflected light beam and an according second reflected light beam can be a predetermined multiple of the wavelength of the light beams by the light source.

102. The detecting device for detecting the rotation of a motor rotor as claimed in claim 101, wherein the arrangement of the convex portions and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

103. The detecting device for detecting the rotation of a motor rotor as claimed in claim 102, wherein the arrangement of the convex portions and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

104. The detecting device for detecting the rotation of a motor rotor as claimed in claim 103, wherein the arrangement of the convex portions and the separating portions therebetween can ensure that the sensor can produce corresponding alternate and consecutive binary code signals according to predetermined rules, which carry information for calculating and judging the rotation of the motor rotor, by reading the first reflected light beams and the second reflected beams.

105. The detecting device for detecting the rotation of a motor rotor as claimed in claim 104, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

106. The detecting device for detecting the rotation of a motor rotor as claimed in claims 90 or 91, wherein the identification mark means can be a colored means.

107. The detecting device for detecting the rotation of a motor rotor as claimed in claim 106, wherein the colored means can be consisted of a series of consecutive colored portions whose color varies from light to dark.

108. The detecting device for detecting the rotation of a motor rotor as claimed in claim 107, wherein the arrangement of the colored means can ensure that the sensor can detect the rotation of the motor rotor by reading the changes of the light beams firstly emitted by the light source and then reflected respectively by corresponding adjacent colored portions of the colored means.

109. The detecting device for detecting the rotation of a motor rotor as claimed in claim 108, wherein the colored portions thereof are arranged so that the reflectivity thereof can vary according to the requirements of the sensor.

110. The detecting device for detecting the rotation of a motor rotor as claimed in claim 108, wherein the colored portions thereof are arranged so that the wavelengths of the reflected light beams by adjacent colored portions can vary according to the requirements of the sensor.

111. The detecting device for detecting the rotation of a motor rotor as claimed in claim 110, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

112. The detecting device for detecting the rotation of a motor rotor as claimed in claim 106, wherein the colored means can be consisted of consecutive colored portions which vary in the aspects of hues, values and/or chromas thereof.

113. The detecting device for detecting the rotation of a motor rotor as claimed in claim 112, wherein the arrangement of the colored means can ensure that the sensor can detect the rotation of the motor rotor by reading the changes of the reflected light beams firstly emitted by the light source and then reflected respectively by corresponding adjacent colored portions of the colored means.

114. The detecting device for detecting the rotation of a motor rotor as claimed in claim 113, wherein the colored portions thereof are arranged so that the reflectivity thereof can vary according to the requirements of the sensor.

115. The detecting device for detecting the rotation of a motor rotor as claimed in claim 113, wherein the colored portions thereof are arranged so that the wavelengths of the reflected light beams by adjacent colored portions can vary according to the requirements of the sensor.

116. The detecting device for detecting the rotation of a motor rotor as claimed in claim 115, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

117. The detecting device for detecting the rotation of a motor rotor as claimed in claim 106, wherein the colored means can be consisted of consecutive colored portions whose colors are different from each other.

118. The detecting device for detecting the rotation of a motor rotor as claimed in claim 117, wherein the arrangement of the colored means can ensure that the sensor can detect the rotation of the motor rotor by reading the changes of the light beams firstly emitted by the light source and then reflected respectively by corresponding adjacent colored portions of the colored means.

119. The detecting device for detecting the rotation of a motor rotor as claimed in claim 118, wherein the colored portions thereof are arranged so that the reflectivity thereof can vary according to the requirements of the sensor.

120. The detecting device for detecting the rotation of a motor rotor as claimed in claim 118, wherein the colored portions thereof are arranged so that the wavelengths of the reflected light beams by adjacent colored portions can vary according to the requirements of the sensor.

121. The detecting device for detecting the rotation of a motor rotor as claimed in claim 120, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve precise detection of the rotation of the motor rotor.

122. The detecting device for detecting the rotation of a motor rotor as claimed in claim 90 or 91, wherein the identification mark means may include a calibration means as a reference mark thereof, and a plurality of slots circumferentially formed on the outer surface of the cylindrical shoulder.

123. The detecting device for detecting the rotation of a motor rotor as claimed in claim 122, wherein the slots are arranged in a way that the distances traveled by first light beams emitted by the light source, which reach and are reflected by the bottoms of the slots, are different from the distances traveled by second light beams emitted by the light source, which reach and are reflected by separating portions between adjacent slots which are protuberant compared with the slots.

124. The detecting device for detecting the rotation of a motor rotor as claimed in claim 123, wherein the traveling distance distinction between an according first reflected light beams and an according second reflected light beams can be a predetermined multiple of the wavelength of the light beams by the light source.

125. The detecting device for detecting the rotation of a motor rotor as claimed in claim 124, wherein the arrangement of the slots and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

126. The detecting device for detecting the rotation of a motor rotor as claimed in claim 125, wherein the arrangement of the slots and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

127. The detecting device for detecting the rotation of a motor rotor as claimed in claim 126, wherein the arrangement of the slots and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

128. The detecting device for detecting the rotation of a motor rotor as claimed in claim 127, wherein the calibration means is arranged among the slots.

129. The detecting device for detecting the rotation of a motor rotor as claimed in claim 128, wherein the calibration means can be a calibration slot whose depth is different from the above slots so that the sensor can detect it by reading the unique distance which the reflected light beam reflected by the bottom of the calibration slot travels to reach the sensor.

130. The detecting device for detecting the rotation of a motor rotor as claimed in claim 128, wherein the calibration means can be a calibration convex portion so that the sensor can detect it by reading the unique distance which the reflected light beam reflected by the calibration convex portion travels to reach the sensor.

131. The detecting device for detecting the rotation of a motor rotor as claimed in claim 128, wherein the calibration means can be a calibration portion with a unique color so that the sensor can detect it by comparing the reflected light beam reflected by the calibration portion and other reflected light beams by the slots and the separating portions therebetween in the aspects of reflectivity or wavelength thereof.

132. The detecting device for detecting the rotation of a motor rotor as claimed in claim 128, wherein the light source can emit light beams with two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

133. The detecting device for detecting the rotation of a motor rotor as claimed in claims 90 or 91, wherein the identification mark means may include a calibration means as a reference mark thereof and a plurality of convex portions circumferentially formed on the outer surface of the cylindrical shoulder.

134. The detecting device for detecting the rotation of a motor rotor as claimed in claim 133, wherein the convex portions are arranged in a way that the distances traveled by first light beams emitted by the light source, which reach and are reflected by the convex portions, are different from the distances traveled by second light beams emitted by the light source, which reach and are reflected by separating portions between adjacent convex portions which are lower compared with the convex portions.

135. The detecting device for detecting the rotation of a motor rotor as claimed in claim 134, wherein the traveling distance distinction between an according first reflected light beam and an according second reflected light beam can be a predetermined multiple of the wavelength of the light beams by the light source.

136. The detecting device for detecting the rotation of a motor rotor as claimed in claim 135, wherein the arrangement of the convex portions and the separating portions therebetween can ensure that the different traveling distances of the according first reflected light beams and the according second reflected light beams can vary consecutively, so that the sensor can produce corresponding consecutive binary code signals, which carry information for calculating and judging the rotation of the motor rotor, by reading the first reflected light beams and the second reflected beams.

137. The detecting device for detecting the rotation of a motor rotor as claimed in claim 136, wherein the arrangement of the convex portions and the separating portions therebetween can ensure that the different traveling distances of the according first reflected light beams and the according second reflected light beams can vary alternately and consecutively, so that the sensor can produce corresponding alternate and consecutive binary code signals, which carry information for calculating and judging the rotation of the motor rotor, by reading the first reflected light beams and the second reflected beams.

138. The detecting device for detecting the rotation of a motor rotor as claimed in claim 137, wherein the arrangement of the convex portions and the separating portions therebetween can ensure that the sensor can produce corresponding alternate and consecutive binary code signals according to predetermined rules thereof, which carry information for calculating and judging the rotation of the motor rotor, by reading the first reflected light beams and the second reflected beams.

139. The detecting device for detecting the rotation of a motor rotor as claimed in claim 138, wherein the calibration means is arranged among the convex portions.

140. The detecting device for detecting the rotation of a motor rotor as claimed in claim 139, wherein the calibration means can be a calibration slot so that the sensor can detect it by reading the unique distance which the reflected light beam reflected by the bottom of the calibration slot travels to reach the sensor.

141. The detecting device for detecting the rotation of a motor rotor as claimed in claim 139, wherein the calibration means can be a calibration convex portion whose height is different from the above convex portions so that the sensor can detect it by reading the unique distance which the reflected light beam reflected by the calibration convex portion travels to reach the sensor.

142. The detecting device for detecting the rotation of a motor rotor as claimed in claim 139, wherein the calibration means can be a calibration portion with a unique color so that the sensor can detect it by comparing the reflected light beam reflected by the calibration portion and other reflected light beams by the convex portions and the separating portions therebetween in the aspect of reflectivity or wavelength thereof.

143. The detecting device for detecting the rotation of a motor rotor as claimed in claim 139, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

144. The detecting device for detecting the rotation of a motor rotor as claimed in claims 90 or 91, wherein the identification mark means can be a circumferential colored means and includes a calibration means as a reference mark thereof.

145. The detecting device for detecting the rotation of a motor rotor as claimed in claim 144, wherein the colored means can be consisted of a series of consecutive colored portions whose color varies from light to dark.

146. The detecting device for detecting the rotation of a motor rotor as claimed in claim 145, wherein the arrangement of the colored means can ensure that the sensor can detect the rotation of the motor rotor by reading the changes of the light beams firstly emitted by the light source and then reflected respectively by corresponding adjacent colored portions of the colored means.

147. The detecting device for detecting the rotation of a motor rotor as claimed in claim 146, wherein the colored portions thereof are arranged so that the reflectivity thereof can vary according to the requirements of the sensor.

148. The detecting device for detecting the rotation of a motor rotor as claimed in claim 146, wherein the colored portions thereof are arranged so that the wavelengths of the reflected light beams by adjacent colored portions can vary according to the requirements of the sensor.

149. The detecting device for detecting the rotation of a motor rotor as claimed in claim 146, wherein the calibration means is arranged among the colored portions.

150. The detecting device for detecting the rotation of a motor rotor as claimed in claim 149, wherein the calibration means can be a calibration slot so that the sensor can detect it by reading the unique distance which the reflected light beam reflected by the bottom of the calibration slot travels to reach the sensor.

151. The detecting device for detecting the rotation of a motor rotor as claimed in claim 149, wherein the calibration means can be a calibration convex portion so that the sensor can detect it by reading the unique distance which the reflected light beam reflected by the calibration convex portion travels to reach the sensor.

152. The detecting device for detecting the rotation of a motor rotor as claimed in claim 149, wherein the calibration means can be a calibration portion with a unique color different from those of the colored portions above so that the sensor can detect it by comparing the reflected light beam reflected by the calibration portion and other reflected light beams by the other colored portions in the aspects of reflectivity or wavelength thereof.

153. The detecting device for detecting the rotation of a motor rotor as claimed in claim 149, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

154. The detecting device for detecting the rotation of a motor rotor as claimed in claim 144, wherein the colored means can be consisted of consecutive colored portions which vary in the aspects of hues, values and/or chromas thereof.

155. The detecting device for detecting the rotation of a motor rotor as claimed in claim 154, wherein the arrangement of the colored means can ensure that the sensor can detect the rotation of the motor rotor by reading the changes of the reflected light beams firstly emitted by the light source and then reflected respectively by corresponding adjacent colored portions of the colored means.

156. The detecting device for detecting the rotation of a motor rotor as claimed in claim 155, wherein the colored portions thereof are arranged so that the reflectivity thereof can vary according to the requirements of the sensor.

157. The detecting device for detecting the rotation of a motor rotor as claimed in claim 155, wherein the colored portions thereof are arranged so that the wavelengths of the reflected light beams by adjacent colored portions can vary according to the requirements of the sensor.

158. The detecting device for detecting the rotation of a motor rotor as claimed in claim 155, wherein the calibration means is arranged among the colored portions.

159. The detecting device for detecting the rotation of a motor rotor as claimed in claim 158, wherein the calibration means can be a calibration slot whose depth is different from the above slots so that the sensor can detect it by reading the unique distance which the reflected light beam reflected by the bottom of the calibration slot travels to reach the sensor.

160. The detecting device for detecting the rotation of a motor rotor as claimed in claim 158, wherein the calibration means can be a calibration convex portion so that the sensor can detect it by reading the unique distance which the reflected light beam reflected by the calibration convex portion travels to reach the sensor.

161. The detecting device for detecting the rotation of a motor rotor as claimed in claim 158, wherein the calibration means can be a calibration portion with a unique color so that the sensor can detect it by comparing the reflected light beam reflected by the calibration portion and other reflected light beams by the colored portions in the aspects of reflectivity or wavelength thereof.

162. The detecting device for detecting the rotation of a motor rotor as claimed in claim 158, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

163. The detecting device for detecting the rotation of a motor rotor as claimed in claim 144, wherein the colored means can be consisted of consecutive colored portions whose colors are different from each other.

164. The detecting device for detecting the rotation of a motor rotor as claimed in claim 163, wherein the arrangement of the colored means can ensure that the sensor can detect the rotation of the motor rotor by reading the changes of the light beams firstly emitted by the light source and then reflected respectively by corresponding adjacent colored portions of the colored means.

165. The detecting device for detecting the rotation of a motor rotor as claimed in claim 164, wherein the colored portions thereof are arranged so that the reflectivity thereof can vary according to the requirements of the sensor.

166. The detecting device for detecting the rotation of a motor rotor as claimed in claim 164, wherein the colored portions thereof are arranged so that the wavelengths of the reflected light beams by adjacent colored portions can vary according to the requirements of the sensor.

167. The detecting device for detecting the rotation of a motor rotor as claimed in claim 164, wherein the calibration means is arranged among the colored portions.

168. The detecting device for detecting the rotation of a motor rotor as claimed in claim 167, wherein the calibration means can be a calibration slot whose depth is different from the above slots so that the sensor can detect it by reading the unique distance which the reflected light beam reflected by the bottom of the calibration slot travels to reach the sensor.

169. The detecting device for detecting the rotation of a motor rotor as claimed in claim 167, wherein the calibration means can be a calibration convex portion so that the sensor can detect it by reading the unique distance which the reflected light beam reflected by the calibration convex portion travels to reach the sensor.

170. The detecting device for detecting the rotation of a motor rotor as claimed in claim 167, wherein the calibration means can be a calibration portion with a unique color so that the sensor can detect it by comparing the reflected light beam reflected by the calibration portion and other reflected light beams by the colored portions in the aspects of reflectivity or wavelength thereof.

171. The detecting device for detecting the rotation of a motor rotor as claimed in claim 167, wherein the light source can emit light beams at two different wavelengths, and the sensor can thus receive and read the light beams with the two different wavelengths respectively reflected from the identification mark means thereby producing according binary code signals carrying more detailed information thereof, whereby the detecting device can achieve very precise detection of the rotation of the motor rotor.

172. The detecting device for detecting the rotation of a motor rotor as claimed in claim 1, wherein the sensor may be a photographic device which can detect the identification mark means.

173. The detecting device for detecting the rotation of a motor rotor as claimed in claim 172, wherein the sensor may be a Charge-Coupled Device (CCD).

174. The detecting device for detecting the rotation of a motor rotor as claimed in claim 172, wherein the sensor may be a Complementary Metal Oxide Semiconductor (CMOS).

175. The detecting device for detecting the rotation of a motor rotor as claimed in claims 173 or 174, wherein the identification means may comprise a series of identification portions which are pre-arranged according to the requirements of the sensor.

176. The detecting device for detecting the rotation of a motor rotor as claimed in claims 173 or 174, wherein the identification means may comprise a series of identification portions which are arranged randomly.

177. The detecting device for detecting the rotation of a motor rotor as claimed in claim 176, wherein the sensor should firstly detect the whole image of the identification means so as to set up a comparative model before the detecting device is used.

178. A detecting device for detecting the rotation of a rotating shaft comprises a light source, an identification mark means which is formed on an integral portion of the rotating shaft and having a specific pattern thereof, and a sensor for light beams which are emitted by the light source and come then from the identification mark means.

179. The detecting device for detecting the rotation of a rotating shaft as claimed in claim 178, wherein the specific pattern of the identification mark means includes a plurality of slots which can render the sensor to detect the rotation of the shaft by reading the differences of the reflected light beams by the identification mark means.

180. The detecting device for detecting the rotation of a rotating shaft as claimed in claim 179, wherein the differences of the reflected light beams may be different wavelengths of the correspondent light beams by the slots and other portions of the identification mark means.

181. The detecting device for detecting the rotation of a rotating shaft as claimed in claim 180, wherein the wavelength differences may be a specific multiple of the wavelength of the light beams.

182. The detecting device for detecting the rotation of a rotating shaft as claimed in claim 178, wherein the specific pattern of the identification mark means includes a plurality of convex portions which can render the sensor to detect the rotation of the shaft by reading the differences of the reflected light beams by the identification mark means.

183. The detecting device for detecting the rotation of a rotating shaft as claimed in claim 182, wherein the differences of the reflected light beams may be different wavelengths of the correspondent light beams by the convex portions and other portions of the identification mark means.

184. The detecting device for detecting the rotation of a rotating shaft as claimed in claim 183, wherein the wavelength differences may be a specific multiple of the wavelength of the light beams.

185. The detecting device for detecting the rotation of a rotating shaft as claimed in claim 178, wherein the identification mark means can be made of a partially transparent materials.

186. The detecting device for detecting the rotation of a rotating shaft as claimed in claim 185, wherein the specific pattern of the identification mark means includes a plurality of slots which can render the sensor to detect the rotation of the shaft by reading the differences of the light beams emitted by the light source and passing through the identification mark means.

187. The detecting device for detecting the rotation of a rotating shaft as claimed in claim 186, wherein the differences of the light beams may be different wavelengths of the correspondent light beams by the slots and other portions of the identification mark means.

188. The detecting device for detecting the rotation of a rotating shaft as claimed in claim 187, wherein the wavelength differences may be a specific multiple of the wavelength of the light beams.

189. The detecting device for detecting the rotation of a rotating shaft as claimed in claim 185, wherein the wherein the specific pattern of the identification mark means includes a plurality of convex portions which can render the sensor to detect the rotation of the shaft by reading the differences of the light beams passing through the identification mark means.

190. The detecting device for detecting the rotation of a rotating shaft as claimed in claim 189, wherein the differences of the light beams may be different wavelengths of the correspondent light beams by the convex portions and other portions of the identification mark means.

191. The detecting device for detecting the rotation of a rotating shaft as claimed in claim 190, wherein the wavelength differences may be a specific multiple of the wavelength of the light beams.

192. The detecting device for detecting the rotation of a rotating shaft as claimed in claims 178, 180 or 185, wherein the light source can emit light beams with two different wavelengths.

193. The detecting device for detecting the rotation of a rotating shaft as claimed in claim 192, wherein the light source may be a pumped solid state laser.

194. The detecting device for detecting the rotation of a motor rotor as claimed in claim 178, wherein the sensor may be a photographic device which can detect the identification mark means.

195. The detecting device for detecting the rotation of a motor rotor as claimed in claim 194, wherein the sensor may be a Charge-Coupled Device (CCD).

196. The detecting device for detecting the rotation of a motor rotor as claimed in claim 191, wherein the sensor may be a Complementary Metal Oxide Semiconductor (CMOS).

197. The detecting device for detecting the rotation of a motor rotor as claimed in claims 195 or 196, wherein the identification means may comprise a series of identification portions which are pre-arranged according to the requirements of the sensor.

198. The detecting device for detecting the rotation of a motor rotor as claimed in claims 195 or 196, wherein the identification means may comprise a series of identification portions which are arranged randomly.

199. The detecting device for detecting the rotation of a motor rotor as claimed in claim 198, wherein the sensor should firstly detect the whole image of the identification means so as to set up a comparative model before the detecting device is used.

200. A detecting device for detecting the rotation of a rotating shaft comprises a light source, a colored means which is formed on an integral portion of the rotating shaft and having a specific pattern thereof, and a sensor for light beams which are emitted by the light source and come then from the identification mark means.

201. The detecting device for detecting the rotation of a rotating shaft as claimed in claim 200, wherein the specific pattern of the colored means includes a plurality of colored portions which has a single color which varies from light to dark, which can render the sensor to detect the rotation of the shaft by reading the differences of the reflected light beams by the identification mark means.

202. The detecting device for detecting the rotation of a rotating shaft as claimed in claim 201, wherein the differences of the reflected light beams may be different wavelengths of the correspondent light beams by the colored portions and other portions of the colored means.

203. The detecting device for detecting the rotation of a rotating shaft as claimed in claim 202, wherein the wavelength differences may be a specific multiple of the wavelength of the light beams.

204. The detecting device for detecting the rotation of a rotating shaft as claimed in claim 200, wherein the specific pattern of the colored means includes a plurality of colored portions whose colors are different from each other, which can render the sensor to detect the rotation of the shaft by reading the differences of the reflected light beams by the colored means.

205. The detecting device for detecting the rotation of a rotating shaft as claimed in claim 204, wherein the differences of the reflected light beams may be different wavelengths of the correspondent light beams by the colored portions and other portions of the colored means.

206. The detecting device for detecting the rotation of a rotating shaft as claimed in claim 205, wherein the wavelength differences may be a specific multiple of the wavelength of the light beams.

207. The detecting device for detecting the rotation of a rotating shaft as claimed in claim 200, wherein the identification mark means can be made of a partially transparent materials.

208. The detecting device for detecting the rotation of a rotating shaft as claimed in claim 207, wherein the specific pattern of the colored means includes a plurality of colored portions which has a single color which varies from light to dark, which can render the sensor to detect the rotation of the shaft by reading the differences of the light beams emitted by the light source and passing through the colored means.

209. The detecting device for detecting the rotation of a rotating shaft as claimed in claim 208, wherein the differences of the light beams may be different wavelengths of the correspondent light beams by the colored portions and other portions of the colored means.

210. The detecting device for detecting the rotation of a rotating shaft as claimed in claim 209, wherein the wavelength differences may be a specific multiple of the wavelength of the light beams.

211. The detecting device for detecting the rotation of a rotating shaft as claimed in claim 207, wherein the specific pattern of the colored means includes a plurality of colored portions whose colors are different from each other, which can render the sensor to detect the rotation of the shaft by reading the differences of the light beams passing through the colored means.

212. The detecting device for detecting the rotation of a rotating shaft as claimed in claim 211, wherein the differences of the light beams may be different wavelengths of the correspondent light beams by the colored portions and other portions of the colored means.

213. The detecting device for detecting the rotation of a rotating shaft as claimed in claim 212, wherein the wavelength differences may be a specific multiple of the wavelength of the light beams.

214. The detecting device for detecting the rotation of a rotating shaft as claimed in claims 200 or 207, wherein the light source can emit light beams with two different wavelengths.

215. The detecting device for detecting the rotation of a rotating shaft as claimed in claim 214, wherein the light source may be a pumped solid state laser.

216. The detecting device for detecting the rotation of a motor rotor as claimed in claim 200, wherein the sensor may be a photographic device which can detect the identification mark means.

217. The detecting device for detecting the rotation of a motor rotor as claimed in claim 216, wherein the sensor may be a Charge-Coupled Device (CCD).

218. The detecting device for detecting the rotation of a motor rotor as claimed in claim 216, wherein the sensor may be a Complementary Metal Oxide Semiconductor (CMOS).

219. The detecting device for detecting the rotation of a motor rotor as claimed in claims 217 or 218, wherein the identification means may comprise a series of identification portions which are pre-arranged according to the requirements of the sensor.

220. The detecting device for detecting the rotation of a motor rotor as claimed in claims 217 or 218, wherein the identification means may comprise a series of identification portions which are arranged randomly.

221. The detecting device for detecting the rotation of a motor rotor as claimed in claim 220, wherein the sensor should firstly detect the whole image of the identification means so as to set up a comparative model before the detecting device is used.

222. A detecting device for detecting the rotation of a rotating shaft comprises an identification mark means positioned beside the rotating shaft and having a specific pattern thereof, and a sensor for detecting light beams coming from the identification mark means, wherein the sensor is positioned on the rotating shaft.

223. The detecting device for detecting the rotation of a rotating shaft as claimed in claim 222, wherein the specific pattern of the identification mark means includes a plurality of slots which are arranged in a cycle and can render the sensor to detect the rotation of the shaft by reading the differences of the reflected light beams by the identification mark means.

224. The detecting device for detecting the rotation of a rotating shaft as claimed in claim 223, wherein the differences of the reflected light beams may be different wavelengths of the correspondent light beams by the slots and other portions of the identification mark means.

225. The detecting device for detecting the rotation of a rotating shaft as claimed in claim 224, wherein the wavelength differences may be a specific multiple of the wavelength of the light beams.

226. The detecting device for detecting the rotation of a rotating shaft as claimed in claim 222, wherein the wherein the specific pattern of the identification mark means includes a plurality of convex portions which are arranged in a cycle and can render the sensor to detect the rotation of the shaft by reading the differences of the reflected light beams by the identification mark means.

227. The detecting device for detecting the rotation of a rotating shaft as claimed in claim 226, wherein the differences of the reflected light beams may be different wavelengths of the correspondent light beams by the convex portions and other portions of the identification mark means.

228. The detecting device for detecting the rotation of a rotating shaft as claimed in claim 227, wherein the wavelength differences may be a specific multiple of the wavelength of the light beams.

229. The detecting device for detecting the rotation of a rotating shaft as claimed in claim 222, wherein the identification mark means can be a colored means including a plurality of colored portions arranged in a cycle which can ensure light beams therefrom back to the sensor changes after reaching the colored means.

230. The detecting device for detecting the rotation of a rotating shaft as claimed in claim 229, wherein a calibration means is arranged among the colored portions of the colored means as a reference mark and is unique so that the light beams therefrom back to the sensor are different those from the colored portions back to the sensor, whereby the sensor can distinguish it from the colored portions.

231. The detecting device for detecting the rotation of a rotating shaft as claimed in claims 229 or 230, wherein the colors of the colored portions can differ from each other so that the light beams from a specific colored portion back to the sensor are different those from the adjacent colored portions thereof back to the sensor.

232. The detecting device for detecting the rotation of a rotating shaft as claimed in claim 222, wherein the identification mark means can be made of a partially transparent materials.

233. The detecting device for detecting the rotation of a rotating shaft as claimed in claim 232, wherein the specific pattern of the identification mark means includes a plurality of slots which can render the sensor to detect the rotation of the shaft by reading the differences of the light beams emitted by the light source and passing through the identification mark means.

234. The detecting device for detecting the rotation of a rotating shaft as claimed in claim 233 wherein the differences of the light beams may be different wavelengths of the correspondent light beams by the slots and other portions of the identification mark means.

235. The detecting device for detecting the rotation of a rotating shaft as claimed in claim 225 wherein the wavelength differences may be a specific multiple of the wavelength of the light beams.

236. The detecting device for detecting the rotation of a rotating shaft as claimed in claim 232, wherein the wherein the specific pattern of the identification mark means includes a plurality of convex portions which can render the sensor to detect the rotation of the shaft by reading the differences of the light beams passing through the identification mark means.

237. The detecting device for detecting the rotation of a rotating shaft as claimed in claim 236, wherein the differences of the light beams may be different wavelengths of the correspondent light beams by the convex portions and other portions of the identification mark means.

238. The detecting device for detecting the rotation of a rotating shaft as claimed in claim 237, wherein the wavelength differences may be a specific multiple of the wavelength of the light beams.

239. The detecting device for detecting the rotation of a rotating shaft as claimed in claims 222 or 232, wherein a light source is further included therewith and is positioned on the rotor for emitting light beams to the identification mark means.

240. The detecting device for detecting the rotation of a rotating shaft as claimed in claim 239, wherein the light source can emit light beams with two different wavelengths.

241. The detecting device for detecting the rotation of a rotating shaft as claimed in claim 240, wherein the light source may be a pumped solid state laser.

242. The detecting device for detecting the rotation of a motor rotor as claimed in claim 240, wherein the sensor may be a photographic device which can detect the identification mark means.

243. The detecting device for detecting the rotation of a motor rotor as claimed in claim 242, wherein the sensor may be a Charge-Coupled Device (CCD).

244. The detecting device for detecting the rotation of a motor rotor as claimed in claim 242, wherein the sensor may be a Complementary Metal Oxide Semiconductor (CMOS).

245. The detecting device for detecting the rotation of a motor rotor as claimed in claims 243 or 244, wherein the identification means may comprise a series of identification portions which are pre-arranged according to the requirements of the sensor.

246. The detecting device for detecting the rotation of a motor rotor as claimed in claims 243 or 244, wherein the identification means may comprise a series of identification portions which are arranged randomly.

247. The detecting device for detecting the rotation of a motor rotor as claimed in claim 246, wherein the sensor should firstly detect the whole image of the identification means so as to set up a comparative model before the detecting device is used.
